(19) United States
(12) Patent Application Publication
(10) Pub. No.: US 2010/0332625 A1
(43) Pub. Date: Dec. 30, 2010

(54) METHOD AND SYSTEM FOR PROTOCOL CONFIGURATION IN WIRELESS COMMUNICATION SYSTEMS

(75) Inventors: Yingzhe WU, San Marcos, CA (US); Junsheng Chu, Nanjing (CN)

Correspondence Address: MORRISON & FOERSTER LLP, 12531 HIGH BLUFF DRIVE, SUITE 100, SAN DIEGO, CA, 92130-2040, US

(73) Assignee: ZTE (USA) INC., San Diego, CA (US)

(21) Appl. No.: 12/823,009

(22) Filed: Jun. 24, 2010

Related U.S. Application Data
(60) Provisional application No. 61/220,119, filed on Jun. 24, 2009.

(51) Int. Cl. G06F 15/177

(52) U.S. Cl. 709/220

(57) ABSTRACT

Described herein are methods and systems for protocol configuration in a wireless communication system. In one embodiment, the system includes an access service network device configured to receive a Dynamic Host Configuration Protocol (DHCP) message, including protocol configuration information of a mobile station, and to relay at least a portion of the protocol configuration information to a data server to which the mobile station seeks access. The protocol configuration information is translated to a protocol used by the access service network device and the data server, before relaying the protocol configuration information. The access service network device can act as a proxy or a relay between the mobile station and the data server. According to an embodiment, the wireless communication system includes a WiMAX communication system.

### CROSS-REFERENCE TO RELATED APPLICATIONS

This application claims priority to U.S. Provisional Patent Application No. 61/220,119 filed on Jun. 24, 2009, entitled “UE Protocol Configuration for DHCP Proxy Mode in WiMAX-3GPP Interworking”, the content of which is incorporated by reference herein in its entirety.

### FIELD OF THE INVENTION

The present invention relates generally to wireless communication networks, and more particularly, to a method and system for protocol configuration among network entities in wireless communication systems.

### BACKGROUND OF THE INVENTION

With the increasing popularity of mobile devices, there exists a need to allow users to attach to various domains, depending on their current location. A user may require access to resources being provided by a visited network different than their home network.

Many details are missing in the current WiMAX-EPC interworking specification. For example, it is not straightforward to use WiMAX access interface, to convey all the parameters/information needed by 3gpp evolved packet core (EPC) to successfully establish an evolved packet system (EPS) bearer. There are several important parameters needed in order for an access service network gateway (ASN-GW) to find the right packet data network gateway (PDN-GW) to which to initiate PDN connection, the Access Point Name (APN) for PDN-GW to connect to an external data network, and Protocol Configuration Option exchanged between a mobile station and the PDN-GW.

Some of these parameters can take default values when they are not available. For example, there is a default APN in a user's subscription profile downloaded from the authentication, authorization and accounting (AAA) server after access authentication and “Attach Type” can assume the “Initial Attach,” if not sent by the mobile station. However, there is a need in the art, for example, for a mechanism by which a mobile station can handle its protocol configuration (e.g., IPv4 and IPv6) when DHCP proxy mode is used in WiMAX ASN, when interworking with 3gpp EPC, for example.

### SUMMARY OF THE INVENTION

The presently disclosed embodiments are directed to solving one or more of the problems presented in the prior art, described above, as well as providing additional features that will become readily apparent by reference to the following detailed description when taken in conjunction with the accompanying drawings.

One exemplary aspect of the present invention is directed to a method of protocol configuration in a wireless communication system. The method includes receiving a Dynamic Host Configuration Protocol (DHCP) message, including protocol configuration information of a mobile station, at an access service network device; and relaying at least a portion of the protocol configuration information to a data server to which the mobile station seeks access. According to one embodiment, the protocol configuration information is translated to a protocol used by the access service network device and the data server, before relaying the protocol configuration information.

Another embodiment is directed to a system for protocol configuration in a wireless communication system. According to this embodiment, the system includes an access service network device configured to receive a DHCP message, including protocol configuration information of a mobile station. The access service network device is further configured to relay at least a portion of the protocol configuration information to a data server to which the mobile station seeks access. The protocol configuration information is translated to a protocol used by the access service network device and the data server, before relaying the protocol configuration information. The access service device network can act as a proxy or a relay between the mobile station and the data server. According to an embodiment, the wireless communication system includes a WiMAX communication system.

### BRIEF DESCRIPTION OF THE DRAWINGS

The features, nature and advantages of the present disclosure will become more apparent from the detailed description set forth below when taken in conjunction with the drawings in which like reference numerals refer to like elements throughout and wherein:

FIG. 1 is a block diagram illustrating an exemplary architecture of a wireless communication system according to an embodiment of the present invention.

FIG. 2 is a block diagram illustrating an exemplary mobile station in a wireless communication network according to an embodiment of the present invention.

FIG. 3 is a block diagram illustrating an exemplary access service network device according to an embodiment of the present invention.

FIG. 4 is a flow diagram illustrating an initial Attach procedure with PMIPv6 on S2a, according to an embodiment of the present invention.

FIG. 5 is a flow diagram of an ASN-GW translating parameters requested by a DHCP to PCO over PMIPv6, according to an embodiment of the present invention.

FIG. 6 is a flow diagram illustrating an ASN-GW acting as a DHCP server towards a mobile station, and acting as a DHCP client towards a PDN-GW, according to an embodiment of the present invention.

FIG. 7 is a flow diagram illustrating an exemplary embodiment where ASN-GW proposes deferred IPv4 address allocation, for example, in PCO if it supports DHCP relay mode, according to an embodiment of the present invention.

### DETAILED DESCRIPTION OF EXEMPLARY EMBODIMENTS OF THE INVENTION

In the following description of exemplary embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the present invention.

As used herein, the term “access service network” (ASN) or access service network device includes without limitation one or more units or modules configured to provide any set of network functions that provide radio access to a mobile station (also referred to herein as “user equipment” (UE)).

As used herein, the term “base station” (BS) includes, without limitation, a generalized equipment set providing connectivity, management, and control of a subscriber station (MSS).

As used herein, the term “connectivity service network” (CSN) includes without limitation any set of network functions that provide IP connectivity services to a mobile station which has IP connectivity capability.

As used herein, the term “mobile station” (MS) includes without limitation a station with mobile service intended to be used while in motion or during halts at unspecified points.

As used herein, the term “reference point” (RP) includes without limitation a conceptual link that connects two groups of functions which reside in different functional entities of an ASN, CSN, or MSS. Note that a “reference point” is not necessarily required to be a physical interface.

As used herein, the term “reference point” includes without limitation a conceptual link that connects two groups of functions which reside in different functional entities of an ASN, CSN or MSS. It is not necessarily a physical interface. It also may encompass the bearer plane methods (e.g., tunneling) to transfer IP data between an ASN and a CSN.

As used herein, the term “home agent” (HA) includes without limitation a router on a mobile node's home network which tunnels a datagram for delivery to the mobile node when it is away from home. It also may maintain current location information for the mobile node.

As used herein, the term “Ethernet Service Home Agent” (eHA) includes without limitation a module with the regular functionality of a home agent as well as bridge functionality. This module can therefore forward, anchor, classify and tunnel pure Ethernet frames instead of IP packets.

As used herein, the term “foreign agent” (FA) includes without limitation a router on a visited network which may tunnel/de-tunnel a datagram for delivery to the mobile node when it is away from home. The foreign agent may also maintain tunneling information for the mobile node.

As used herein, the term “Ethernet Service Foreign Agent” (eFA) includes without limitation a module with the regular functionality of a foreign agent as well as the capability to receive, classify, and tunnel pure Ethernet frames instead of IP packets.

As used herein, the term “local mobility anchor” (LMA) includes without limitation a home agent for a mobile node in the Proxy Mobile IPv6 domain. The local mobility anchor may serve as the topological anchor point for the mobile node's home prefix(es) and manage the mobile node's reachability (binding) state. The local mobility anchor can have the functional capabilities of a home agent as defined in Mobile IPv6 based specification with the additional capabilities required for supporting Proxy Mobile IPv6 protocol.

As used herein, the term “mobile access gateway” (MAG) includes without limitation a function on an access router that manages the mobility-related signaling for a mobile node that is attached to its access link. It can be responsible for tracking the mobile node's movements to and from the access link and for signaling the mobile node's local mobility anchor.

As used herein, the term “Simple Ethernet Service” includes without limitation a service which uses non-MIP based functional entities (i.e., an Ethernet bridge in a CSN) to provide Ethernet service through a WiMAX network. The bridge attached to the CSN may provide a dedicated bridge port for each of the mobile stations anchored at the CSN.

As used herein, the term “MIP-based Ethernet Service” includes without limitation a service which deploys Mobile IP to provide a dynamic tunnel setup on RD so as to realize wide area roaming and mobility for Ethernet-CS-based terminals. Due to its dynamic behavior, the R3 interface may be fully defined for MIP-based Ethernet Services.

As used herein, the term “WiMAX network” includes without limitation a network architecture based on the IEEE 802.16 d/e wireless standard.

As used herein, the term “access router” (AR) includes without limitation a first hop router located within an ASN that is used to provide Simple IP traffic routing services.

The word “exemplary” is used herein to mean “serving as an example or illustration.” Any aspect or design described herein as “exemplary” is not necessarily to be construed as preferred or advantageous over other aspects or designs.

Reference will now be made in detail to aspects of the subject technology, examples of which are illustrated in the accompanying drawings, wherein like reference numerals refer to like elements throughout.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

A WiMAX network can provide IP and Ethernet Services to an end user based on service provider business requirements, subscriber profiles, network architecture and network entity capability information. As will be described in more detail below, in order to provide a successful user service session, several major network entities may be involved, including, for example, an access service network (ASN), a home connectivity service network (H-CSN), and/or a visited connectivity service network (V-CSN). Each network entity may be capable of providing multiple Ethernet and IP services. Capabilities that may be associated with an ASN may include, for example, Dynamic Host Configuration Protocol (DHCP)v4 Relay, DHCPv6 Relay, DHCPv4 Proxy, DHCPv6 Proxy, FA, PMIP Client, AR with IPv4 transport, AR with IPv6 transport, eAFF with IPv4 transport, and eAFF with iPv6 transport. Capabilities that may be associated with a V-CSN may include, for example, v-DHCPv4 Server, v-DHCPv6 Server, MIP-HAv4, MIP-HAv6, MIP-eHAv4, and MIP-eHAv6. Since each network entity may have different Ethernet Service and IP service capabilities, various embodiments of the present invention are directed to a novel method of service capability negotiation and authorization among the various network entities.

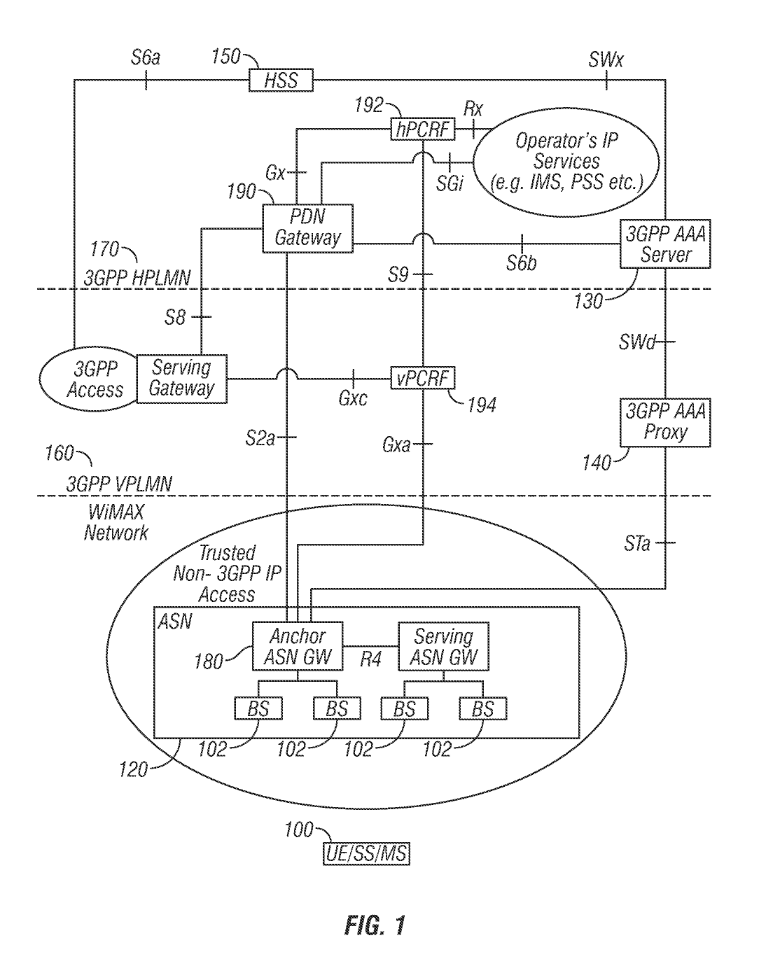

FIG. 1 is an illustration of an exemplary architecture of a wireless communication system according to one embodiment of the present invention. The wireless communication network may be a WiMAX network that complies with the Institute of Electrical and Electronics Engineers (IEEE) 802.16 communication system protocol. However, the present invention is not limited to any particular network type, and various network technologies performing service capability negotiation may be implemented without departing from the scope of the present disclosure.

In current WiMAX access network interworking with 3gpp Evolved Packet Core (EPC) network architecture, the network model, according to certain embodiments, is shown in FIG. 1.

According to the embodiment depicted in FIG. 1, a wireless communication network includes a mobile station 100. An ASN 120 may provide a set of network functions that support radio access to mobile station 100. Thus, when the mobile station 100 is in close proximity to an ASN 120, the mobile station 100 may attempt to acquire Ethernet and/or IP services from the ASN 120 in a Home Public Land Mobile Network (HPLMN) 170 or a Visitor Public Land Mobile Network (VPLMN) 160, for example.

Reference point S2a is the interface between WiMAX ASN 120 (via ASN-GW 180, which may be communicatively coupled to any number of BSs 102) and 3gpp PDN-GW 190 to carry control information and IP packets. It can use IETF standardized protocol RFC 5213 Proxy Mobile IPv6, and customized for use in 3gpp EPC.

In some embodiments, the ASN 120 can negotiate and determine which Ethernet and/or IP services will be provided to mobile station 100. The wireless communication network of FIG. 1 may also include an AAA proxy 140, which may act as a proxy to the AAA server 130. That is, the ASN 120 may transfer IP data to AAA server 130 by “tunneling” through AAA proxy 140 using connections STa and SWd. Thereby, data may be transferred to and from home subscriber server (HSS) 150. Note that for the purposes of this example, the AAA proxy 140 and the AAA server 130 may exist within VPLMN 160 and home HPLMN 170, respectively.

As shown in FIG. 1, to implement any network configuration, MS100 may be connected to ASN 120 by a physical hard-wire or wireless connection. Similarly all other connections shown in FIG. 1 may be hard-wire or wireless connections. The ASN 120 itself may be connected wirelessly or otherwise to one or more other ASNs (not shown). Note, however, that the architectural arrangement depicted in FIG. 1 is merely illustrative in nature; various other network entities and combinations thereof may be included without departing from the scope of the present invention.

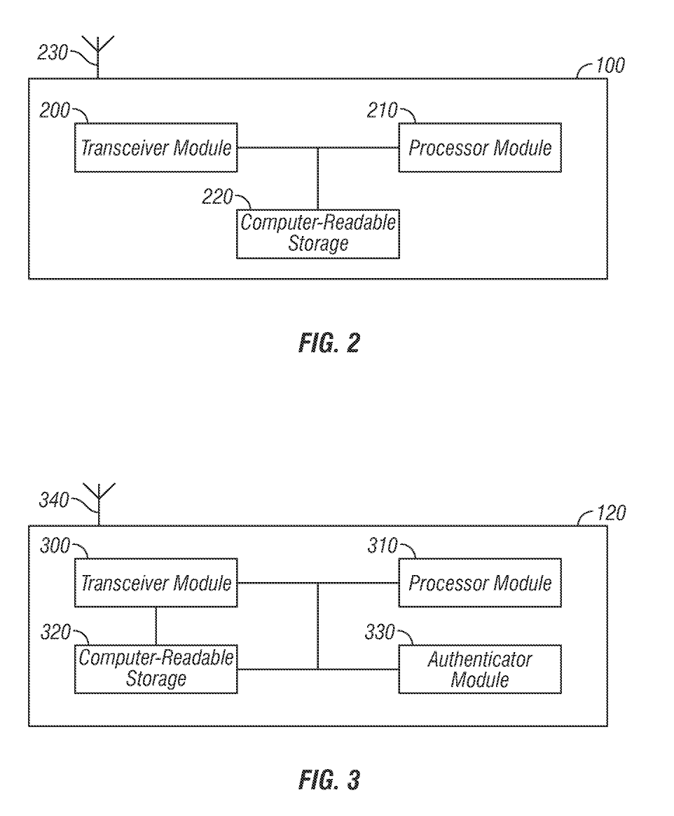

FIG. 2 is an illustration of an exemplary mobile station 100 in a wireless communication network according to one embodiment of the present invention. In an exemplary embodiment, the mobile station 100 may be a user device such as a mobile phone. Alternately, mobile station 100 may be a personal digital assistant (PDA) such as a Blackberry device, MP3 player or other similar portable device. According to still other embodiments, the mobile station 100 may be a personal wireless computer such as a wireless notebook computer or a wireless palmtop computer.

As shown in FIG. 2, the exemplary mobile station 100 may include a transceiver module 200 configured to support alternate or additional wireless data communication protocols. These protocols include, without limitation, future variations of IEEE 802.16 (such as 802.16e, 802.16m, etc).

The transceiver module 200 may generally enable bi-directional communication between mobile station 100 and various network entities via antenna 230. Note that the transceiver module 200 may be configured to support internet or WiMAX traffic as well as to provide an 802.3 Ethernet interface.

In some embodiments, the mobile station 100 comprises a processor module 210 that is configured to carry out the functions, techniques, and processing tasks associated with the operation of mobile station 100. The processor module 210 may include any number of devices or device combinations as known in the art. These include, for example, general purpose processors, content addressable memory modules, digital signal processors, application-specific integrated circuits, field programmable gate arrays, programmable logic arrays, discrete gate or transistor logic, or other such electronic components.

Furthermore, the steps of a method or algorithm described in connection with the embodiments disclosed herein may be embodied directly in hardware, in firmware, in a software module executed by processor module 210, or in any practical combination thereof. A software module may reside in computer-readable storage 220, which may be realized as RAM memory, flash memory, ROM memory, EPROM memory, EEPROM memory, registers, a hard disk, a removable disk, a CD-ROM, or any other form of storage medium known in the art. In this regard, computer-readable storage 220 may be coupled to processor module 210 so that processor module 210 can read information from, and write information to, the computer-readable storage 220. In some embodiments, the computer-readable storage 220 includes cache memory for storing temporary variables or other intermediate information during execution of instructions by the processor module 210. In some embodiments, the computer-readable storage 220 also includes non-volatile memory.

The computer-readable storage 220 may also include a frame structure database (not shown) in accordance with some embodiments of the present invention. This frame structure database may be configured to store, maintain, and provide data as needed to support the functionality of a wireless communication system. Additionally, the frame structure database may include a lookup table for purposes of storing frame structure parameters. Note that the frame structure database may consist of either a local database (e.g., coupled to the processor module 210), or a remote database (e.g., a central network database).

FIG. 3 is an illustration of an exemplary ASN 120 according to one embodiment of the present invention. The ASN 120 may include a transceiver module 300 coupled to an antenna 340, a processor module 310, and computer-readable storage 320. The transceiver module 300, the processor module 310, and the computer-readable storage 320 may be configured similarly to the transceiver module 200, the processor module 210 and computer-readable storage 220 as described above with reference to FIG. 2. The ASN 120 may additionally include an authenticator module 330 for transmitting service capability data associated with the ASN 120 to a remote module via transceiver module 300. This service capability data may be used by the H-CSN 130 to determine a set of Ethernet and/or IP services authorized for the mobile station 100.

Of course, one of ordinary skill in the art would realize that the above-described MS100 and the above described ASN 120 are merely exemplary in nature. Various other components and component combinations may also be utilized without departing from the scope of the present disclosure.

In 3gpp access, MS100 can send an Attach message to the Mobility Management Entity (MME) to initiate a network access attempt. One of the parameters sent in the Attach message is PCO (Protocol Configuration Option(s)). It is used to convey protocol configuration data exchange between MS100 and PDN-GW 190, if MS 100 can not run the IETF standardized protocol directly. For example, the PCO can contain DNS (Domain Name Server) and a P-CSCF (Proxy-Call Session Control Function) that are needed by the MS100 to initiate an IP session. If the MS100 supports IETF standardized protocol, such as DHCPv4 or DHCPv6 in the WiMAX case, for example, these parameters may be defined in their corresponding protocols. Then, the PCO may not be needed for these parameters.

For a trusted non-3gpp access network, such as WiMAX, the ASN-GW 190 can be configured to support either a DHCP relay mode or a DHCP proxy mode. In a DHCP relay mode, the DHCP message sent by the MS100 will be relayed to the PDN-GW 190 after a PMIP6 tunnel has been established between ASN-GW 180 and PDN-GW 190. In this case, the PDN-GW 190 can act as a DHCP server, supplying all needed information (e.g., DNS and P-CSCF) in a DHCP protocol exchange. In DHCP proxy mode, the DHCP message sent by the MS100, and will be locally processed by the ASN-GW 180, hence not relayed to PDN-GW 190. In this case, there is a need to translate the protocol configuration information from DHCP to PMIP6 protocol used between ASN-GW 180 and PDN-GW 190. Various embodiments described herein address such a mechanism.

Upon receiving a DHCPDISCOVER message from MS100 in the IPv4 case, for example, the ASN-GW 180 (if it acts as a DHCP relay) can establish a PMIP6 tunnel to PDN-GW 190 without asking for the protocol configuration parameters. If the ASN-GW 180 wants to act as a DHCP proxy, it can translate the requested DNS and/or P-CSCF server information from DHCP protocol to a PCO attribute in PMIP6 protocol to be exchanged with PDN-GW 190, and vice versa on the message going back.

Upon receiving RS (Router Solicitation) from MS100 in the IPv6 case, the ASN-GW 180 (if it acts as a DHCP relay) can establish a PMIP6 tunnel to PDN-GW 190 without asking for these protocol configuration parameters. If the ASN-GW 180 wants to act as a DHCP proxy, it will include the DNS and/or P-CSCF server information in the PCO attribute in PMIP6 protocol to be exchanged with PDN-GW 190, even if they are not received from MS100 in the RS message. The PDN-GW 190 will provide these protocol configuration parameters in PCO and ASN-GW 180 can store them locally, in computer readable storage 320 for example. After the IPv6 SLAAC (Stateless Address Autoconfiguration), the MS100 can initiate stateless DHCPv6 protocol for protocol configuration, and ASN-GW 180 can supply this information using its stored values.

By adopting this translation mechanism, there is no need to expand DHCP message to carry PCO, and also a mechanism is provided to support DHCP proxy mode on ASN-GW 180. MS100 protocol configuration is used for DHCP proxy mode using a translation mechanism between DHCP and PCO in PMIP6 protocol.

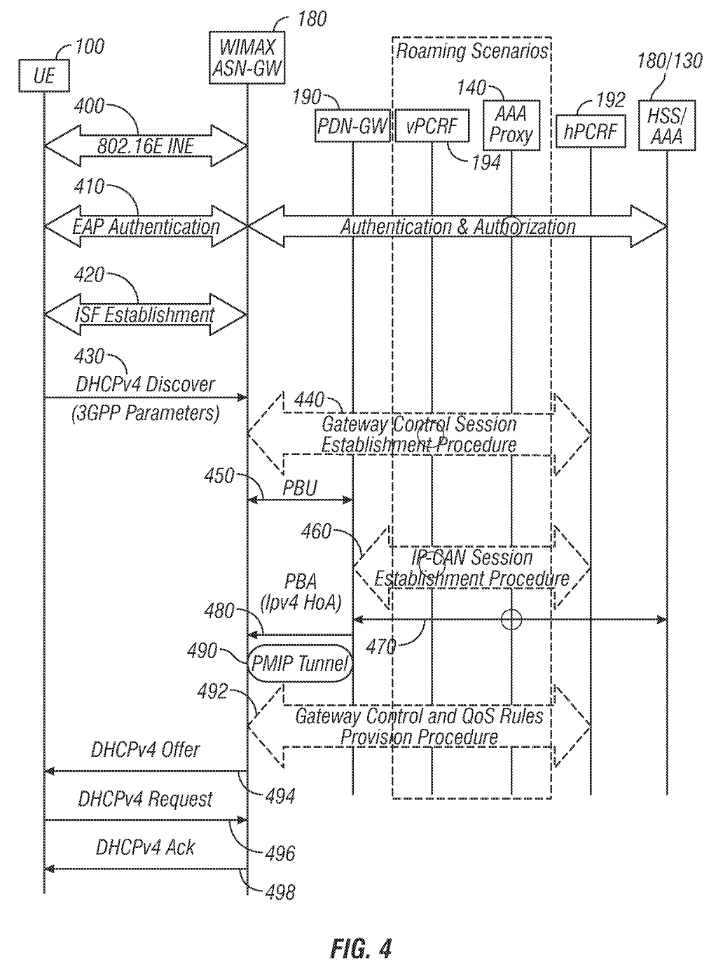

FIG. 4 is a flow diagram illustrating an Initial Attach procedure with PMIPv6 on S2a, according to an embodiment. The flow diagram is described with respect to WiMAX specific triggers and procedures for exemplary purposes; however, one of ordinary skill in the art would realize that various types of wireless communication systems may be implemented without departing from the scope of the present disclosure.

The initial WiMAX network entry procedures, for example are performed at operation 400. These procedures are as per the WiMAX NWG 1.5 specification, for example, which is incorporated herein by reference.

At operation 410, the EAP authentication procedure is initiated and performed involving MS100. The PDN Gateway address may be determined at this point.

At operation 420, after successful authentication and authorization, ASN 120 can try to establish the Initial Service Flow(s) to MS100 according to the authorized PDN type downloaded during access authentication. If IPv4v6 is authorized, for example, ASN 120 can attempt to establish one IPv4 ISF and one IPv6 ISF, according to one embodiment. MS100 may reduce the ISFs to only the PDN type it supports, according to an embodiment.

At operation 430, MS100 can initiate either DHCPv4 for IPv4 or RS for IPv6 addressing, or both for a default PDN connection. The Attach will always be treated as an “Initial Attach,” according to the present embodiment.

In operations 440 to 492, the PDN Type sent in a Proxy Binding Update (PBU) can be set to the type of ISFs established between ASN 120 and MS100 in operation 430 (e.g., IPv4, IPv6 or IPv4v6). The requested IP address type can be set corresponding to the PDN Type. If the PDN Type is IPv4, for example, the requested IP address may be IPv4 HoA. If PDN Type is IPv6, for example, the requested IP address may be IPv6 HNP. If the PDN Type is IPv4v6, for example, both IPv4 HoA and IPv6 HNP may be requested. The protocol configuration parameters in PCO are set and used according to the following clarification:
If ASN 120 is configured to support a DHCP proxy, the PCO in PBU can contain additional protocol configuration parameters necessary for MS100 IP stack configuration. These parameters may include a DNS server or P-CSCF server, depending on what MS100 has asked for in the DHCPDISCOVER message. ASN 120 may also be responsible to translate the configuration parameters received from PCO in a Proxy Binding Ack (PBA) sent by the PDN-GW 190, into the DHCPOFFER and DHCPACK messages sent to MS 100. For IPv6 MS100, for example, these parameters may be sent in PCO even if they are not received in RS. IPv6 MS100 can use stateless DHCP for parameter configuration after it has configured the IPv6 address using SLAAC, for example. In this case, ASN 120 is responsible to translate the configuration parameters received from PCO into the DHCPv6 Reply message; and
If ASN 120 is configured to support a DHCP relay, configuration parameters need not be included in PCO. They will be provided by the PDN-GW after PMIP tunnel establishment, when ASN 120 relays the DHCP message to the PDN-GW 190, for example. The PDN-GW 190 can act as a DHCP server and provide all requested configuration parameters. It is noted that the PCC procedure may assume support of 3GPP Rel-8 PCC framework, according to various embodiments.

At operation 494, ASN-GW 180 sends the DHCPv4 offer to MS100 with assigned MN-HoA or RA with assigned IPv6 HNP, for example. At operations 496-498, MS100 completes the DHCP procedure configuring the previously offered IP address. IP connectivity between MS100 and the PDN-GW 190 for a default PDN connection or for the APN provided by MS100 is set for uplink and downlink connectivity.

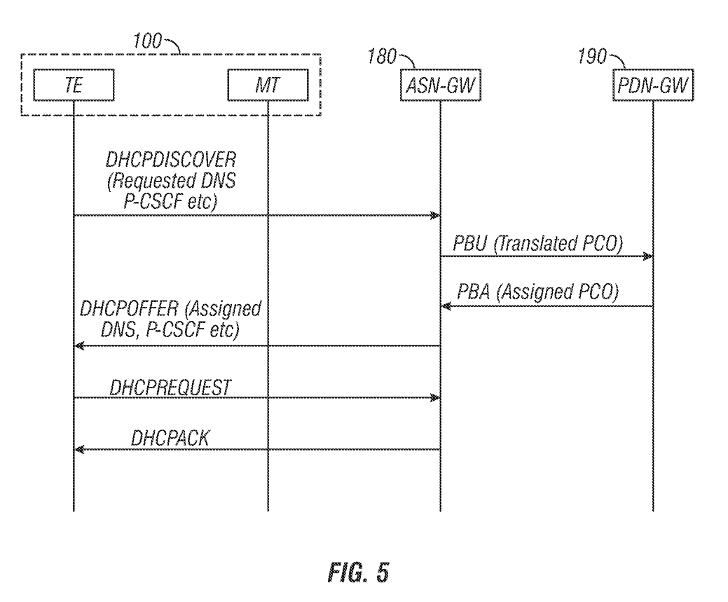

One option for DHCP proxy support on ASN-GW 180, for example is depicted in FIG. 5. FIG. 5 is a flow diagram of ASN-GW 180 translating parameters requested by DHCP to PCO over PMIP6, according to an embodiment. MS100, including terminal equipment (TE) with the mobile terminal (MT), transmits a DHCPDISCOVER message to ASN-GW 180, via transceiver module 200, for example. Of course, the TE may be included within and/or communicatively coupled to MT. ASN-GW 180 then transmits the PBU (translated PCO) to PDN-GW 190, via transceiver module 300, for example. PDN-GW 190 may return a PBA with the assigned PCO to ASN-GW 180.

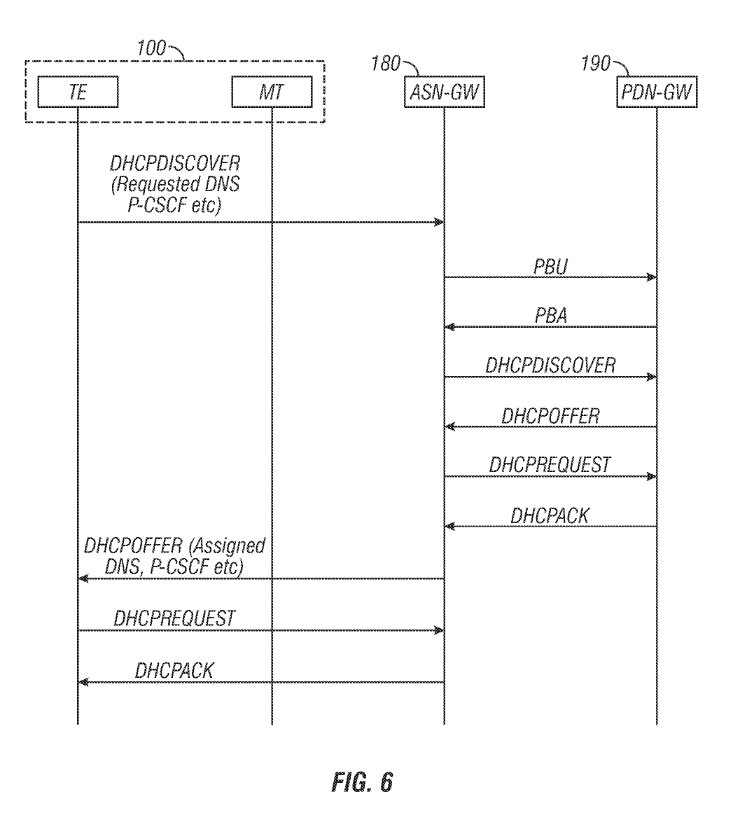

The embodiment depicted in FIG. 5 is distinguishable from the embodiment depicted in FIG. 6, which shows another option where ASN-GW 180 acting as DHCP server towards MS100, and acting as DHCP client towards PDN-GW 190. In FIG. 6, The PBU and PBA are transmitted between the ASN-GW 180 and the PDN-GW 190, similarly to that shown in FIG. 5. However, thereafter, ASN-GW 180 then transmits a DHCPDISCOVER message to PDN-GW 190, which may return a DHCPOFFER message. ASN-GW 180 can transmit a DHCPREQUEST, which can be acknowledged by PDN-GW 190 with a DHCPACK message. Accordingly, ASN-GW 180 is acting as a client with respect to PDN-GW 190, similarly to how MS100 acts towards ASN-GW 180.

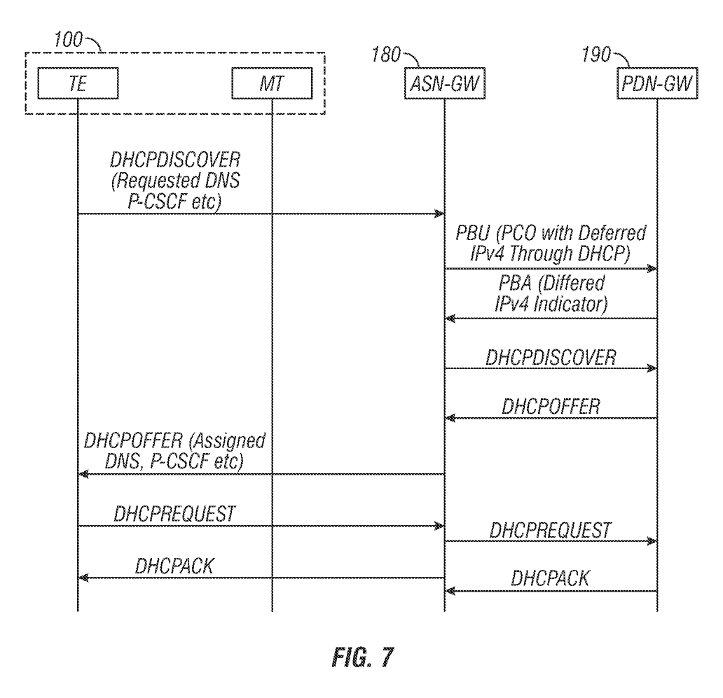

FIG. 7 is a flow diagram illustrating an exemplary embodiment where ASN-GW 180 proposes deferred IPv4 address allocation, for example, to PDN=GW 190 in PCO if it supports DHCP relay mode, for example.

As shown in FIG. 7, PDN-GW 190 can acknowledge (PBA) with a deferred IPv4 indicator. ASN-GW 180 then transmits a DHCPDISCOVER message to PDN-GW 190, which may return a DHCPOFFER message. ASN-GW 180 can relay the DHCPOFFER message with an assigned DNS, P-CSCF, etc. to MS100. MS100 can then transmit a DHCPREQUEST message to ASN-GW 180, which relays the DHCPREQUEST to PDN-GW 190. PDN-GW 190 can acknowledge the DHCPREQUEST with a DHCPACK message to ASN-GW 180, which in turn relays the acknowledgment to MS100.

Purposes of a protocol configuration options information element include: transfer external network protocol options associated with a PDP context activation, and transfer additional (protocol) data (e.g. configuration parameters, error codes or messages/events) associated with an external protocol or an application

With the use of PCO, configuration protocol (octet 3) Bits: 3 2 1; 0 0 0 (PPP for use with IP PDP type). At least the following protocol identifiers may be supported in this version of the protocol:

C021H (LCP);

C023H (PAP);

C223H (CHAP); and

8021H (IPCP).

Additional parameters (octets w+1 to z) include, but are not limited to:

### MS100 to Network Direction (Upstream):

0001H (P-CSCF Address Request);

0002H (IM CN Subsystem Signaling Flag);

0003H (DNS Server Address Request);

0004H (Not Supported);

0005H (MS100 Support of Network Requested Bearer Control indicator);

0006H (Reserved);

0007H (DSMIPv6 Home Agent Address Request;

0008H (DSMIPv6 Home Network Prefix Request);

0009H (DSMIPv6 IPv4 Home Agent Address Request);

000AH (IP address allocation via NAS signalling);—can be used for DHCP proxy mode, for example;

000BH (IPv4 address allocation via DHCPv4).—can be used for DHCP relay mode, for example;

### Network to MS100 Direction (Downstream):

0001H (P-CSCF Address);

0002H (IM CN Subsystem Signaling Flag);

0003H (DNS Server Address);

0004H (Policy Control rejection code);—used for secondary PDP context, for example;

0005H (Selected Bearer Control Mode;—

0006H (Reserved);

0007H (DSMIPv6 Home Agent Address);

0008H (DSMIPv6 Home Network Prefix);

0009H (DSMIPv6 IPv4 Home Agent Address).

An external host connected to MT can be able to use DHCP for protocol configuration, these include parameters DNS, P-CSCF or other parameters it deems necessary.

An external host connected to MT may not be able to extend DHCP to support 3gpp specific parameters (APN, Attach Type, PCO etc), according to various embodiments, and also may not understand any 3gpp extension the network sends to it (e.g., in DHCPOFFER or DHCPACK).

However, WiMAX should be able to support external host connected to MT that uses plain DHCP, for example. Default behaviors of the network can be specified when 3gpp specific parameters are not received. For example:

APN—there may be a default APN, if not received;

Attach Type—default behavior may be initial attach; and/or

PDN Type—depending on what version of specific IP message is received over air interface (e.g., DHCPv4 for IPv4 and Router Solicitation or DHCPv6 for IPv6).

Although the present invention has been fully described in connection with embodiments thereof with reference to the accompanying drawings, it is to be noted that various changes and modifications will become apparent to those skilled in the art. Such changes and modifications are to be understood as being included within the scope of the present invention as defined by the appended claims.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method of protocol configuration in a wireless communication system, comprising:
receiving a Dynamic Host Configuration Protocol (DHCP) message, including protocol configuration information of a mobile station, at an access service network device; and
relaying at least a portion of the protocol configuration information to a data server to which the mobile station seeks access, wherein
the protocol configuration information is translated to a protocol used by the access service network device and the data server, before relaying the protocol configuration information.

2. The method of claim 1, wherein the wireless communication system includes a WiMAX communication system.

3. The method of claim 1, wherein the protocol used by the access service network device and the packet data network is PMIP6.

4. The method of claim 1, wherein the protocol configuration information includes at least one of a domain name server (DNS) and a proxy-call session control function (P-CSCF) required to initiate an IP session.

5. The method of claim 4, wherein the protocol configuration of the mobile station is IPv4.

6. The method of claim 5, further comprising:
establishing a tunnel to the data server; and
relaying the DHCP message to the data server, without obtaining additional protocol configuration parameters.

7. The method of claim 5, further comprising:
translating at least one of the DNS and the P-CSCF from DHCP protocol to the protocol used by the access service network device and the data server; and
transmitting the translated at least one of the DNS and the P-CSCF to the data server; and
receiving from the data server the at least one of the DNS and the P-CSCF in a protocol configuration option message to be stored.

8. The method of claim 4, wherein the protocol configuration of the mobile station is IPv6.

9. The method of claim 8, further comprising:
establishing a tunnel to the data server; and
relaying the DHCP message to the data server, without obtaining additional protocol configuration parameters.

10. The method of claim 8, further comprising:
translating at least one of the DNS and the P-CSCF from DHCP protocol to the protocol used by the access service network device and the data server;
transmitting the translated at least one of the DNS and the P-CSCF to the data server;
receiving from the data server the at least one of the DNS and the P-CSCF in a protocol configuration option message to be stored; and
supplying protocol information based on the stored protocol configuration option message to the mobile station.

11. A system for protocol configuration in a wireless communication system, comprising:
an access service network device configured to receive a Dynamic Host Configuration Protocol (DHCP) message, including protocol configuration information of a mobile station, and to relay at least a portion of the protocol configuration information to a data server to which the mobile station seeks access, wherein
the protocol configuration information is translated to a protocol used by the access service network device and the data server, before relaying the protocol configuration information.

12. The system of claim 11, wherein the wireless communication system includes a WiMAX communication system.

13. The system of claim 11, wherein the protocol used by the access service network device and the packet data network is PMIP6.

14. The system of claim 11, wherein the protocol configuration information includes at least one of a domain name server (DNS) and a proxy-call session control function (P-CSCF) required to initiate an IP session.

15. The system of claim 14, wherein the protocol configuration of the mobile station is IPv4.

16. The system of claim 15, wherein the access service network device is further configured to:
establish a tunnel to the data server; and
relay the DHCP message to the data server, without obtaining additional protocol configuration parameters.

17. The system of claim 15, wherein the access service network device is further configured to:
translate at least one of the DNS and the P-CSCF from DHCP protocol to the protocol used by the access service network device and the data server; and
transmit the translated at least one of the DNS and the P-CSCF to the data server; and
receive from the data server the at least one of the DNS and the P-CSCF in a protocol configuration option message to be stored.

18. The system of claim 14, wherein the protocol configuration of the mobile station is IPv6.

19. The system of claim 18, wherein the access service network device is further configured to:
establish a tunnel to the data server; and
relay the DHCP message to the data server, without obtaining additional protocol configuration parameters.

20. The system of claim 18, wherein the access service network device is further configured to:
translate at least one of the DNS and the P-CSCF from DHCP protocol to the protocol used by the access service network device and the data server;
transmit the translated at least one of the DNS and the P-CSCF to the data server;
receive from the data server the at least one of the DNS and the P-CSCF in a protocol configuration option message to be stored; and
supply protocol information based on the stored protocol configuration option message to the mobile station.
